(19) United States
(12) Patent Application Publication
(10) Pub. No.: US 2006/0133556 A1
(43) Pub. Date: Jun. 22, 2006

(54) Device, system and method for obtaining timing information and ranging

(75) Inventor: Amites Sarkar, Memphis, TN (US)

Correspondence Address: PHILIPS ELECTRONICS NORTH AMERICA CORPORATION;INTELLECTUAL PROPERTY & STANDARDS, 1109 MCKAY DRIVE, M/S-41SJ, SAN JOSE, CA, 95131, US

(73) Assignee: KONINKLIJKE PHILIPS ELECTRONICS N.V., EINDHOVEN (NL)

(21) Appl. No.: 10/536,213

(22) PCT Filed: Nov. 11, 2003
(86) PCT No.: PCT/IB03/05089

§ 371 Date: Feb. 9, 2006

(30) Foreign Application Priority Data
Nov. 26, 2002 (GB) 0227503.0

(51) Int. Cl. H04L 7/00

(52) U.S. Cl. 375/356

(57) ABSTRACT

A system includes first (1) and one or more second devices (2). A first signal (61) and a second signal (62) are transmitted from the first (1) to second (2) device and a third signal (63) is transmitted from the second to the first device. The times of these signals (61, 62, 63) being transmitted and received are measured and used to calculate timing information including a correction for different clock rates in first and second local clocks in the first and second devices.

This invention relates to a system and a method for obtaining timing information between first and second devices, and in particular to a scheme of ranging using this timing information.

Ranging involves measuring the distance between two electronic devices A and B by passing signals between them. Assume that both devices A and B have clocks therein. Typically, A sends a signal to B, on reception of which B immediately sends a signal back to A. A then calculates the difference between the time between sending its signal and receiving the signal back from B, divides this by two, and multiplies by the speed to obtain the distance, or range, from A to B.

This method, using only the clock located in A, avoids any problems that might otherwise be caused if A and B's clocks are not synchronised. However, a problem occurs if there is a delay in transmitting a signal back from B to A, which will cause very significant inaccuracy in the range measured.

Any method of correcting for this using both A's clock and B's clock needs to take account of the fact that A's and B's clocks are not synchronised.

A prior proposal is known from “Protocols for Co-operating Localisers to determine range” of the report entitled “Low-power, miniature, Distributed Position Location and Communication Devices Using Ultra-Wideband, Nonsinusoidal Communication Technology” prepared by Aetherwire & Location Inc for the US Advanced Research Projects Agency/Federal Bureau of Investigation (Contract J-FBI-94-058) in July 1995. At the time of writing, a version of this report is available from http://www.aetherwire.com.

In this report, a method of ranging is proposed in which device B transmits a delay time representing the time according to B's clock that it takes B to reply to the signal to A back to A. This allows A to correct for the delay.

However, this approach assumes that A's clock and B's clock run at exactly the same rate. Any discrepancy from this will cause errors.

There is thus a need for a method that can deal with unsynchronised clocks that may run at different rates.

According to the invention there is provided a method of obtaining timing information between first and second devices having respective first and second local clocks, including:

transmitting a first signal from the first device to the second device at a first time t1 relative to the first local clock;

measuring the second time t2 relative to the second local clock that the first signal arrives at the second device;

transmitting a second signal from the first device to the second device at a third time t3, different to t1, relative to the first local clock;

measuring the second time t4 relative to the second local clock that the second signal arrives at the second device;

transmitting a third signal from the second device to the first device at a fifth time t5 relative to the second local clock;

measuring the sixth time t6 relative to the first local clock at which the third signal arrives at the first device; and

calculating timing information from the first, second, third, fourth, fifth and sixth times, including correcting for different clock rates and clock times in the first and second local clocks.

The method according to the invention thus uses the timing information from three signals to correct for offset clocks and different clock rates in the local clocks, and hence does not require the different clocks to have exactly the same rate.

The transmitter and receiver are preferably radio frequency transmitters and receivers. Such radio signals have a signal speed that is c, the speed of light in air.

The method may calculate a measure a of the rate of the second local clock relative to the first local clock. In preferred embodiments,

$$a = \frac{( t 4 - t 2 )}{( t 3 - t 1 )}$$

The range r between first and second devices may be calculated from the times recorded and the signal speed c using:

$$r = \frac{c}{2} ( t 6 - t 1 - \frac{( t 5 - t 2 )}{a} )$$

In order to collect the time information together in the first device the third signal may include the second, fourth and fifth times.

In alternative embodiments, a separate signal may be transmitted from the second to the first device including the second, fourth and fifth times.

Alternatively, it will be noted that the calculation of delay and range only require (t4−t2) and (t5−t2) so that if only delay and range information are required (t4−t2) and (t5−t2) may be transmitted instead.

Moreover, it is not necessary to collect the information in the first device. It is also possible to send a signal from the first to the second device including the first, third and sixth times to allow the second device to carry out the calculations. A further possibility is to send all necessary data to a third device to carry out the calculations.

The system may correct the times for known delays, for example in filters or other components in the devices.

In another aspect, the invention relates to a system for obtaining timing information, comprising:

a first device having a first local clock, a transmitter and a receiver, arranged:
to transmit a first signal at a first time t1 relative to the first local clock;
to transmit a second signal at a third time t3 relative to the first local clock; and
to receive a third signal and to measure the sixth time t6 relative to the first local clock that the third signal arrives at the first device;

and a second device having a second local clock, a transmitter and a receiver, arranged:
to receive the first signal and to measure the second time t2 relative to the second local clock that the first signal arrives at the second device;
to receive the second signal and to measure the fourth time t4 relative to the second local clock that the second signal arrives at the second device; and
to transmit the third signal at a fifth time t5 relative to the second local clock;

the system being arranged to calculate timing information from the first, second, third, fourth, fifth and sixth times including correcting for different clock rates and clock times in the first and second local clocks.

The first device may be a mobile station and the second device a first base station, and the system may further include further base stations each having a local clock. Each further base station may be arranged to receive first and second further base station signals and to measure the times that they arrive at the further base station relative to the further base station local clock; and to transmit a further response signal at a given time relative to the further base station local clock. The system may calculate the ranges of the mobile station from each of the base stations using the times of the signals transmitted between the mobile station and each of the base stations and to calculate from the ranges the position of the mobile station.

The signals transmitted from the mobile station to each of the base stations can be broadcast signals common to each of the base stations, or alternatively separate message signals may be used for each base station. Accordingly, in a preferred embodiment, the first and second signals transmitted from the mobile station to the base station are also received in the further base stations as the first and second further base station signals, but wherein the third signal transmitted back from the first base station is distinct from the further response signals transmitted back from each of the further base stations. This approach of using broadcast signals avoids the need for the mobile station to know which base stations are in range when transmitting the first and second signals.

The invention also relates to the individual devices, including in one aspect a device for operation together with a second device having a second local clock, the device comprising:

a first local clock;

a transmitter arranged to transmit to the second device a first signal at a first time t1 relative to the first local clock and to transmit to the second device a second signal at a third time t3 relative to the first local clock; and

a receiver arranged to receive a third signal from the second device and to measure its arrival time at a sixth time t6 relative to the first local clock; and

a calculation unit arranged to receive timing information from the second device including a second time t2 when the second device receives the first signal according to the second local clock, a fourth time t4 when the second device receives the second signal according to the second local clock and a fifth time t5 when the second device transmits the third signal according to the second local clock; and to calculate timing information from the first, second, third, fourth, fifth and sixth times including correcting for different clock rates and clock times in the first and second local clocks.

It will be noted that in the above device the calculation unit is provided in the first device.

As mentioned above, it is also possible to carry out the calculations in the second device and accordingly in another aspect there is provided a device for operation together with a first device having a first local clock, the device comprising:

a second local clock;

a receiver arranged to receive first and second signals from the first device and to measure the arrival time of the first signal as a second time t2 according to the second local clock and to measure the arrival time of the second signal as a fourth time t4 according to the second local clock; and

a transmitter arranged to transmit to the first device a third signal at a fifth time t5 relative to the second local clock; and

a calculation unit arranged to receive timing information from the first device including a first time t1 when the first device transmits the first signal according to the first local clock, a third time t3 when the first device transmits the third signal according to the first local clock and a sixth time t6 when the first device receives the sixth signal according to the first local clock; and to calculate timing information from the first, second, third, fourth, fifth and sixth times including correcting for different clock rates and clock times in the first and second local clocks.

Embodiments of the present invention will now be described, purely by way of example, with reference to the accompanying drawings in which:

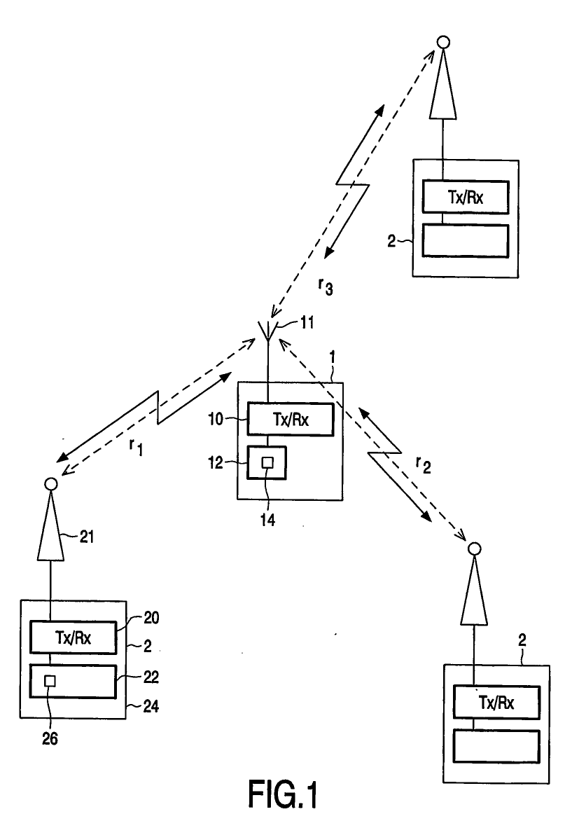

FIG. 1 shows a mobile cellular telephone mobile station ranging to a plurality of nearby cellular telephone network base stations;

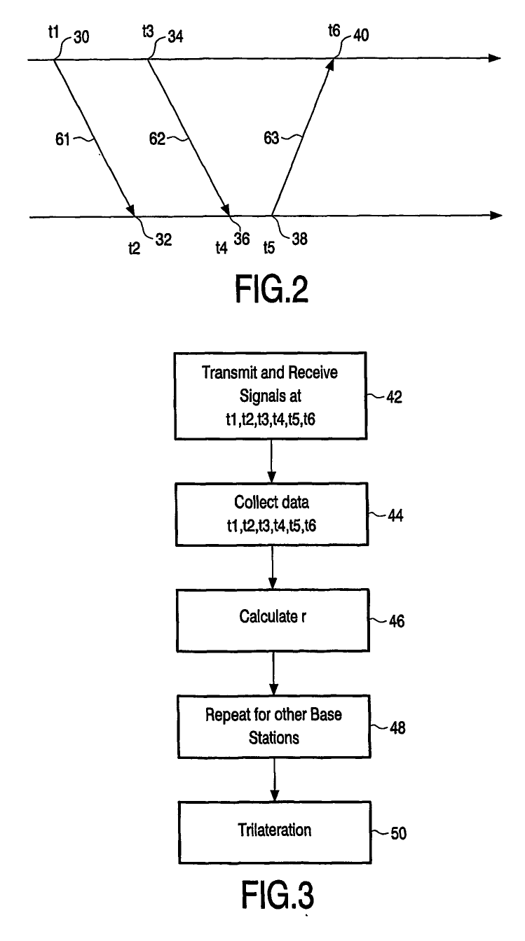

FIG. 2 illustrates the exchange of signals; and

FIG. 3 shows a flow diagram of the operation of the ranging of the present invention.

FIG. 1 shows a mobile cellular telephone 1 having a communications transmitter and receiver 10 connected to a communications antenna 11 and controlled by a communications microprocessor 12, including a first local clock 14.

The figure also shows three base stations 2 each comprising a communications transmitter and receiver 20 connected to a communications antenna 21 and controlled by a communications microprocessor 22 including a second local clock 26.

In use, the mobile cellular telephone is registered with a principal 24 one of the base stations 2 facilitating voice and data communication with that principal base station 24 and the corresponding cellular telephone network. Such communication may include, for example, voice telephony, text messaging, and accessing the internet. As the design and manufacture of such telephones and base stations for two-way communications within a cellular telephone network are well known, those parts which are not directly related to the present invention will not be described further.

In a number of cases, the mobile user may wish to make a position fix of the location of the mobile station. For example, when making an emergency call the mobile station may automatically determine the position and pass this position onto the emergency service operator, known as the public safety answer point (PSAP) in the US. In order to obtain a position fix, the mobile telephone MS must range to at least three base stations of known location. It is also possible to range to additional base stations, although this is not shown.

As shown in FIG. 2, in accordance with the invention, the system carries out the following steps.

First (step 30), a first signal 61 is transmitted from the mobile station at a first time t1 relative to the local clock 14 in the mobile station, which will be called mobile local clock in the following.

This signal is received (step 32) at the base station and the time of its arrival is measured. This measured arrival time will be referred to as second time t2 relative to the local clock 26 of the base station. Then, a second signal 62 is transmitted (step 34) from the mobile station at a third time t3 different to t1, the time t3 again being measured on the mobile local clock. This signal is received (step 36) at the base station and its arrival time measured to be a fourth time t4 according to the base station local clock. Then, a third signal 63 is transmitted (step 38) from the base station to the mobile station at a fifth time t5 relative to the base station local clock, received (step 40) in the mobile station and measured as a sixth time t6 measured by the mobile station local clock.

The step of transmitting and receiving the signals is shown generally in FIG. 3 as step 42.

It is necessary to collect the measured times together to carry out the position calculations. In the embodiment described, the calculation is carried out in the mobile station 1. The information about the times measured in the base station 2 is transmitted in the third signal from the base station to the mobile station which accordingly includes the times t2, t4 and t5. When the mobile station receives the third signal, it collects together the timing data (step 44) by storing the data together in its memory (part of communications processor 12). As part of this step, it corrects the times for known delays in the transmission and reception of signals in the mobile and base stations 1,2.

The mobile station then calculates (step 46) the range between the mobile station 1 and the base station 2 from the times recorded and the speed of light c using:

$$r = \frac{c}{2} ( t 6 - t 1 - \frac{( t 5 - t 2 )}{a} ) , where$$

$$a = \frac{( t 4 - t 2 )}{( t 3 - t 1 )} .$$

The ratio a is a measure of the speed of the base station local clock relative to the mobile local clock.

This procedure is repeated (step 48) by the mobile station with at least two further base stations, to calculate the ranges from the mobile station to these additional base stations also.

Trilateration (step 50) in the mobile station is then used to determine the mobile station's position. Trilateration is a simple geometric technique well known in the art and so it will not be described further.

The mobile station position is then transmitted to the principal base station 24 with which the mobile station is registered for the purposes of voice and data communication and forwarded to the emergency service operator and thereby enabling the user of the telephone to receive prompt, location specific assistance.

Preferably, the times t1, t2, t3, t4, t5 and t6 are measured to nanosecond resolution to enable ranging to within a few meters.

Specific methods for measuring the time of transmission and reception of timing signals are well known and accordingly will not be described further. The skilled person will understand that delays may occur in the transmitter and receiver caused by filters, analogue to digital converters and the like which will appear as part of the time of flight measurements and these delays may need to be subtracted from the measured ranges. It should however be noted that the relative clock speed measurement a is insensitive to such delay assuming that the delays are constant.

In a second embodiment, the base stations 2 are the base stations of an in-house or local network, and the mobile station 1 is the corresponding mobile station.

The base station and mobile station otherwise function as described above to carry out the positioning.

From reading the present disclosure, other variations and modifications will be apparent to persons skilled in the art. Such variations and modifications may involve equivalent and other features which are already known in the design, manufacture and use of communications and positioning systems and which may be used in addition to or instead of features described herein. Although claims have been formulated in this application to particular combinations of features, it should be understood that the scope of disclosure also includes any novel feature or any novel combination of features disclosed herein either explicitly or implicitly or any generalisation thereof, whether or not it mitigates any or all of the same technical problems as does the present invention. The applicants hereby give notice that new claims may be formulated to any such features and/or combinations of such features during the prosecution of the present application or of any further applications derived therefrom.

Although the invention has been described above using the measurement of three ranges, it is possible to range to more than three base stations and to resolve the resulting over-determined set of equations using a best fit type iterative method to provide a position fix with improved accuracy and tolerance to error. Moreover, the first and second timing signals transmitted by the telephone mobile station may be received and measured by all three base stations, or indeed any base station in range. This avoids the need to send different first and second signals to different base stations.

Moreover, although the above description is in terms of an emergency situation, the same procedure may be carried out whenever the user of the mobile station wishes to know the user's position.

Moreover, it is not necessary that the ranging steps are initiated by the mobile station nor that the calculation is carried out in the mobile station. Accordingly, one of the base stations may initiate the ranging steps, and in this instance it may be convenient to carry out the calculations in the base station.

1. A method of obtaining timing information between first and second devices having respective first and second local clocks, including:
transmitting a first signal from the first device to the second device at a first time t1 relative to the first local clock;
measuring the second time t2 relative to the second local clock that the first signal arrives at the second device;
transmitting a second signal from the first device to the second device at a third time t3, different to t1, relative to the first local clock;
measuring the second time t4 relative to the second local clock that the second signal arrives at the second device;
transmitting a third signal from the second device to the first device at a fifth time t5 relative to the second local clock;
measuring the sixth time t6 relative to the first local clock at which the third signal arrives at the first device; and
calculating timing information from the first, second, third, fourth, fifth and sixth times, including correcting for different clock rates and clock times in the first and second local clocks.

2. A method according to claim 1 including:
subtracting the second time from the fourth time to obtain a measure of the time between the first and second signals according to the second local clock;
subtracting the first time from the third time to obtain a measure of the time between the first and second signals according to the first local clock; and
dividing the time between the first and second signals according to the second device clock by the time between the first and second signals according to the first device clock to obtain a measure of the rate of the second local clock relative to the first local clock.

3. A method according to claim 1 wherein the third signal includes the measured second, fourth and fifth times to transmit the second fourth and fifth times to the first device.

4. A method according to claim 1 including correcting the first, second, third, fourth, fifth and sixth times for predetermined delays in the first (1) and second (2) devices.

5. A method according to claim 1, wherein the range r is calculated from the times recorded and the signal speed c using:
$$r = \frac{c}{2} ( t 6 - t 1 - \frac{( t 5 - t 2 )}{a} ) , where$$
$$a = \frac{( t 4 - t 2 )}{( t 3 - t 1 )}$$

6. A method of positioning of a mobile station, including calculating a range between a plurality of base stations and the mobile station using for each base station a method according to claim 5 in which the base station is the second station and the mobile station the first station to calculate the range; and
carrying out trilateration to determine the position of the mobile station using the ranges of the mobile station from the base stations.

7. A system for obtaining timing information, comprising:
a first device having a first local clock, a transmitter and a receiver, arranged:
to transmit a first signal at a first time t1 relative to the first local clock;
to transmit a second signal at a third time t3 relative to the first local clock; and
to receive a third signal and to measure the sixth time t6 relative to the first local clock that the third signal arrives at the first device; and a second device having a second local clock, a transmitter and a
receiver, arranged:
to receive the first signal and to measure the second time t2 relative to the second local clock that the first signal arrives at the second device;
to receive the second signal and to measure the fourth time t4 relative to the second local clock that the second signal arrives at the second device; and
to transmit the third signal at a fifth time t5 relative to the second local clock;
the system being arranged to calculate timing information from the first, second, third, fourth, fifth and sixth times including correcting for different clock rates and clock times in the first and second local clocks.

8. A system according to claim 7 wherein the range r between the first and second devices is calculated from the times recorded and the speed of light c using:
$$r = \frac{c}{2} ( t 6 - t 1 - \frac{( t 5 - t 2 )}{a} ) , where$$
$$a = \frac{( t 4 - t 2 )}{( t 3 - t 1 )}$$

9. A system according to claim 8, wherein the first device is a mobile station and the second device is a first base station,
the system including further base stations each having a local clock, each arranged:
to receive first and second further base station signals and to measure the times that they arrive at the further base station relative to the further base station local clock; and
to transmit a further response signal at a given time relative to the further base station local clock;
wherein the system is arranged to calculate the ranges of the mobile station from each of the base stations using the times of the signals transmitted between the mobile station and each of the base stations and to calculate from the ranges the position of the mobile station.

10. A system according to claim 9 wherein the first and second signals transmitted from the mobile station to the base station are also received in the further base stations as the first and second further base station signals, but wherein the third signal transmitted back from the first base station is distinct from the further response signals transmitted back from each of the further base stations.

11. A device for operation together with a second device having a second local clock, the device comprising:
a first local clock;
a transmitter arranged to transmit to the second device a first signal at a first time t1 relative to the first local clock and to transmit to the second device a second signal at a third time t3 relative to the first local clock; and
a receiver arranged to receive a third signal from the second device and to measure its arrival time at a sixth time t6 relative to the first local clock; and
a calculation unit arranged to receive timing information from the second device including a second time t2 when the second device receives the first signal according to the second local clock, a fourth time t4 when the second device receives the second signal according to the second local clock and a fifth time t5 when the second device transmits the third signal according to the second local clock; and to calculate timing information from the first, second, third, fourth, fifth and sixth times including correcting for different clock rates and clock times in the first and second local clocks.

12. A device for operation together with a first device having a first local clock, the device comprising:
a second local clock (26);
a receiver arranged to receive first and second signals from the first device and to measure the arrival time of the first signal as a second time t2 according to the second local clock and to measure the arrival time of the second signal as a fourth time t4 according to the second local clock; and
a transmitter arranged to transmit to the first device a third signal at a fifth time t5 relative to the second local clock; and
a calculation unit arranged to receive timing information from the first device including a first time t1 when the first device transmits the first signal according to the first local clock, a third time t3 when the first device transmits the third signal according to the first local clock and a sixth time t6 when the first device receives the sixth signal according to the first local clock; and to calculate timing information from the first, second, third, fourth, fifth and sixth times including correcting for different clock rates and clock times in the first and second local clocks.
